(19) United States
(12) Patent Application Publication
(10) Pub. No.: US 2010/0306019 A1
(43) Pub. Date: Dec. 2, 2010

(54) SYSTEM AND METHOD FOR TASK ASSIGNMENT AND ALERT

(75) Inventor: Srikanth Mandava, Hyderabad (IN)

Correspondence Address: SCHWEGMAN, LUNDBERG & WOESSNER, P.A., P.O. BOX 2938, MINNEAPOLIS, MN, 55402, US

(73) Assignee: Computer Associates Think, Inc., Islandia, NY (US)

(21) Appl. No.: 12/476,854

(22) Filed: Jun. 2, 2009

(51) Int. Cl. G06Q 10/00; G06F 17/30; G06F 17/40; H04W 24/00

(52) U.S. Cl. 705/9; 705/7; 455/456.1; 707/E17.014; 707/E17.018; 707/E17.044

(57) ABSTRACT

A computerized process includes using a processor to receive data associated with a mobile location device such as a mobile phone. The data permits a determination of a location of the mobile location device. The data is used to determine if a person associated with the mobile location device is away from a particular location such as a place of business. If so, the processor automatically assigns a task of the person associated with the mobile phone to a second person. In another embodiment, the processor automatically transmits an alert to a second person as a function of the location of the mobile location device.

### TECHNICAL FIELD

The present disclosure relates to a task assignment and alert system and method, and in an embodiment, but not by way of limitation, to a task assignment and alert system that uses a device capable of providing location information.

### BRIEF DESCRIPTION OF THE DRAWINGS

FIGS. 1A and 1B illustrate a list of steps and features in an example embodiment of a process to reassign tasks as a function of the location of a person as determined using a device capable of providing location information.

FIG. 2 illustrates a list of steps and features of an example embodiment of a process to transmit an alert as a function of the location of a person as determined by a device capable of providing location information.

FIG. 3 is a diagram illustrating an example system for locating a person using a device capable of providing location information.

FIG. 4 illustrates a block diagram of an example embodiment of a computer system that can be used in connection with the present disclosure.

### SUMMARY

A computerized process includes using a processor to determine from a database an association between a device capable of providing location information and a person. The processor receives data associated with the location device. The processor automatically assigns a task of the person associated with the location device to a second person. In another embodiment, the processor automatically transmits an alert to a second person as a function of the location of the location device.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus of embodiments of the invention. A number of figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

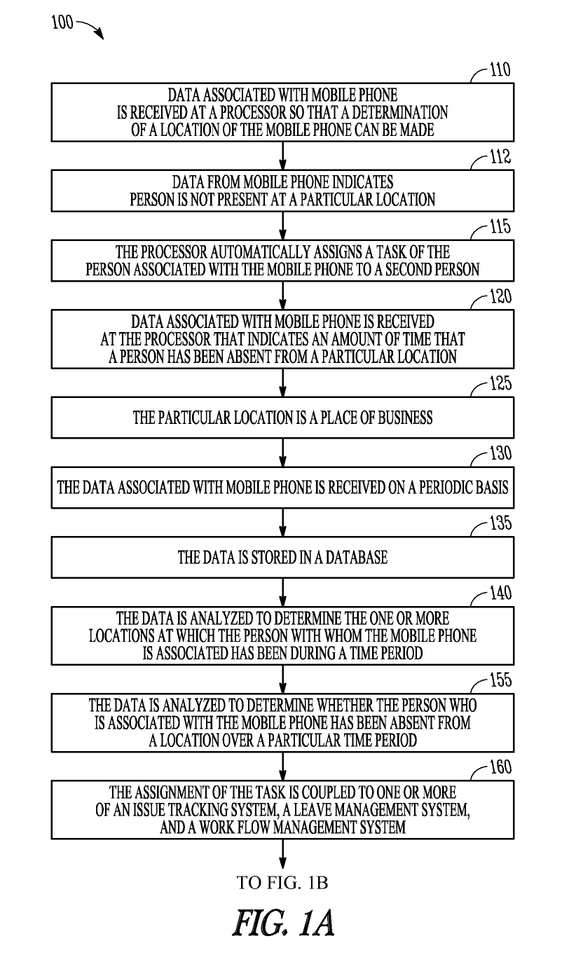

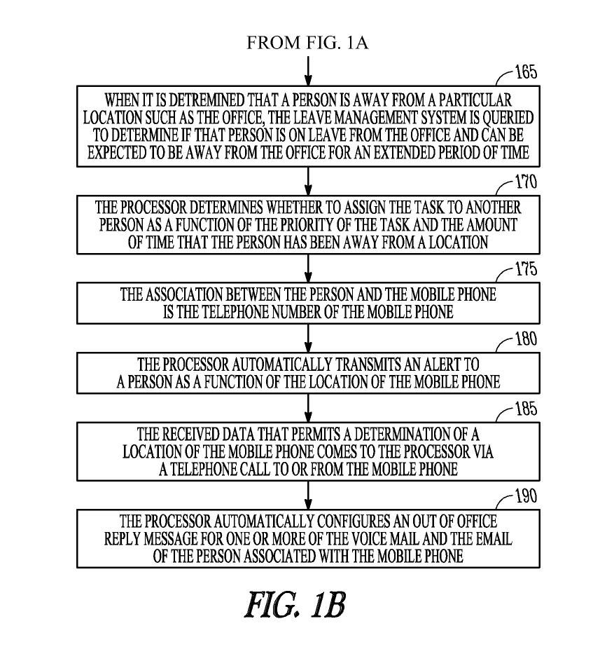

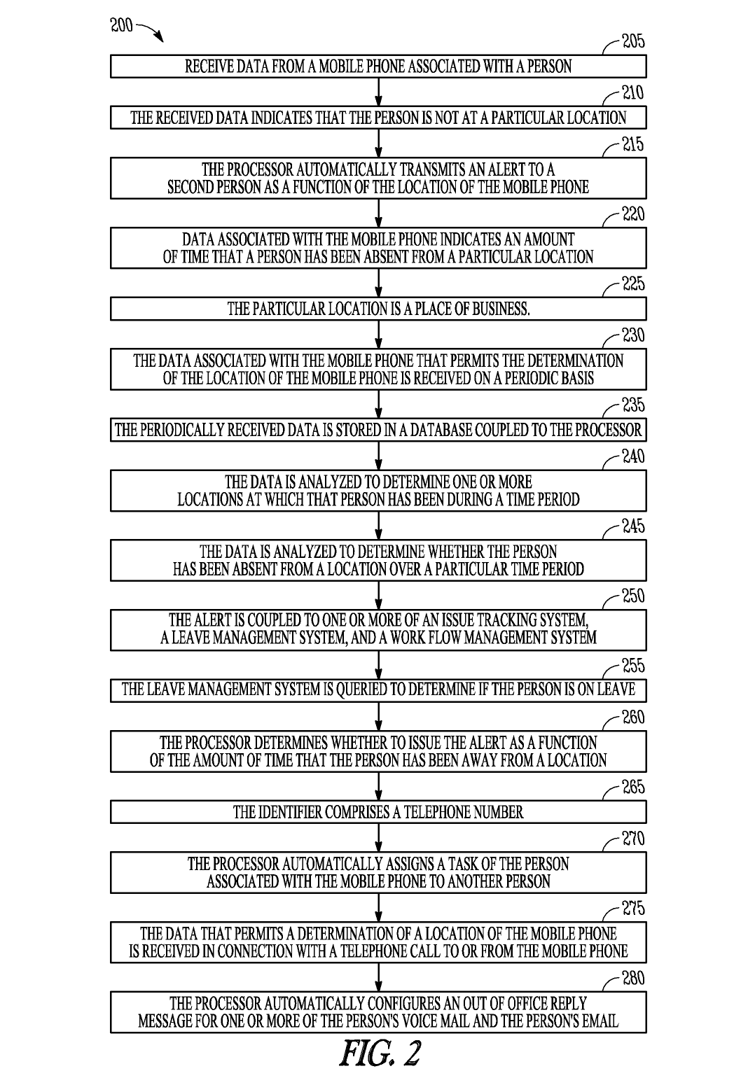

FIGS. 1A, 1B, and 2 are lists of steps and features of example processes 100 and 200 for assigning tasks and/or transmitting alerts as a function of the location of a person as determined by a device capable of providing location information (location device) that is associated with that person. While the present disclosure focuses on a mobile phone as the location device, other units such as pagers, personal data assistants (PDAs), GPS-enabled wrist watches, a Wi-Fi enabled laptop, or other devices capable of providing location information could be used. FIGS. 1A, 1B, and 2 include a number of process blocks identified by unique numbers. Though arranged serially in the examples of FIGS. 1A, 1B, and 2, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 1A and 1B, a process 100 includes at 110 a step of receiving at a processor data that is associated with a mobile phone or other location device. This data can be transmitted from the mobile phone itself, or it can be transmitted by a service provider associated with a mobile phone. This data permits a determination of a location of the mobile phone and the location of a person to whom a task has been assigned. Global positioning technology can be used to determine the location. The data may indicate that the person is not present at a particular location, such as a place of business as indicated at 112. At 115, the processor automatically assigns the task of the person associated with the mobile phone to a second person. As noted, in an embodiment, this assignment of the task occurs when the location of the person associated with the mobile phone indicates that that person will not be able to attend to the task, because, for example, the person is away from the office as indicated by the location of his or her mobile phone. In another embodiment, the processor is used to determine from a database the association of a mobile phone and the person. This association can include a phone number, an address, or some other identifier that can be used to relate the person and the mobile phone. The database can also associate more than one person with a particular mobile phone (for example if the mobile phone is a company-owned mobile phone), or the database can associate more than one mobile phone with a particular person.

At 120, data associated with the mobile phone is received at the processor that indicates an amount of time that a person has been absent from a particular location. One manner in which this can be accomplished is to set a timer when the person leaves the location of interest, and then read the timer thereafter to determine how long the person has been away from the location. For example, when a person leaves his or her place of business as noted at 125, that person can start the timer on his or her mobile phone, and subsequent reads of that timer can provide the amount of time that that person has been away from the office.

At 130, the data associated with the mobile phone is received on a periodic basis. This periodic reception of data permits a determination of a series of locations of the mobile phone. The data is stored in a database at 135. The data can then be analyzed at 140 to determine the one or more locations at which the person with whom the mobile phone is associated has been during a time period. In this manner, not only can the locations at which a person has been during a time period be determined, but estimates can be made on the earliest time that a person may return to a particular location. For example, if the data associated with the mobile phone indicates that the person is moving farther and farther away from a particular location, such as that person's office, it is evident that it will be a longer amount of time until that person returns to the office.

In addition to determining a series of locations of a person and his or her mobile phone, at 155, the data that is received on a periodic basis is analyzed to determine whether the person who is associated with the mobile phone has been absent from a location over a particular time period. This can be implemented with a timer as disclosed in the previous paragraph. In another embodiment, an initial inquiry to the mobile phone and reception of data from the phone serves as a baseline. Thereafter, subsequent inquiries can be used to determine the time that a person has been absent from the location.

At 160, the assignment of the task is coupled to one or more of an issue tracking system, a leave management system, and a work flow management system. With the issue tracking and work flow management systems, the issue tracking and work flows can be automatically altered if the absence of a person will cause a change in the issue tracking or work flow. As a specific example illustrated at 165, when the computerized process 100 determines that a person is away from a particular location such as the office, the process at 165 can then query the leave management system to determine if that person is officially on a leave from the office, and can be expected to be away from the office for an extended period of time (either business trip, vacation, or other personal reason).

At 170, the processor determines whether to assign the task to another person as a function of the priority of the task and the amount of time that the person has been away from a location. In most instances, there is an inverse relationship between the priority of the task and the time that a person has been away from the office, such that, for example, a task with a high priority will be reassigned to another person even when the person has been away from the office for a relatively short period of time.

At 175, the association between the person and the mobile phone is the telephone number of the mobile phone. While this may be the most common association, it should be noted that other associations can also be used such as a URL address or a unique identifier stored in the mobile phone for this purpose. At 180, the processor automatically transmits an alert to a person as a function of the location of the mobile phone. The person who receives the alert could be the person to whom the task is assigned, or it could be a completely different person. At 185, the received data that permits a determination of a location of the mobile phone comes to the processor via a telephone call to or from the mobile phone. At 190, the processor automatically configures an out of office reply message for one or more of the voice mail and the email of the person associated with the mobile phone.

Referring now to FIG. 2, a computerized process 200 includes using a processor at 205 to receive data from a mobile phone or other location device that is associated with a person. At 210, the data indicates that the person is not at a particular location. At 215, the processor automatically transmits an alert to a second person as a function of the location of the mobile phone.

Continuing on with the process 200 of FIG. 2, data associated with the mobile phone is received at 220. This data indicates an amount of time that a person has been absent from a particular location. As noted at 225, the particular location could be a place of business.

At 230, the data that is associated with the mobile phone and that permits the determination of the location of the mobile phone is received on a periodic basis. At 235, this data is stored in a database coupled to the processor. At 240, the data is analyzed to determine one or more locations at which that person has been during a time period, and at 245, the data is analyzed to determine whether the person has been absent from a location over a particular time period.

At 250, the alert is coupled to one or more of an issue tracking system, a leave management system, and a work flow management system. At 255, the leave management system is queried to determine if the person is on leave. At 260, the processor determines whether to issue the alert as a function of the amount of time that the person has been away from a location. At 265, the identifier comprises a telephone number. At 270, the processor automatically assigns a task of the person associated with the mobile phone to another person. At 275, the data that permits a determination of a location of the mobile phone is received in connection with a telephone call to or from the mobile phone. For example, if the person associated with a mobile phone calls his place of business, the system can be configured to automatically determine his location, and then take further action (such as reassigning a task) if the system determines that such action is appropriate. At 280, the processor automatically configures an out of office reply message for one or more of the person's voice mail and the person's email.

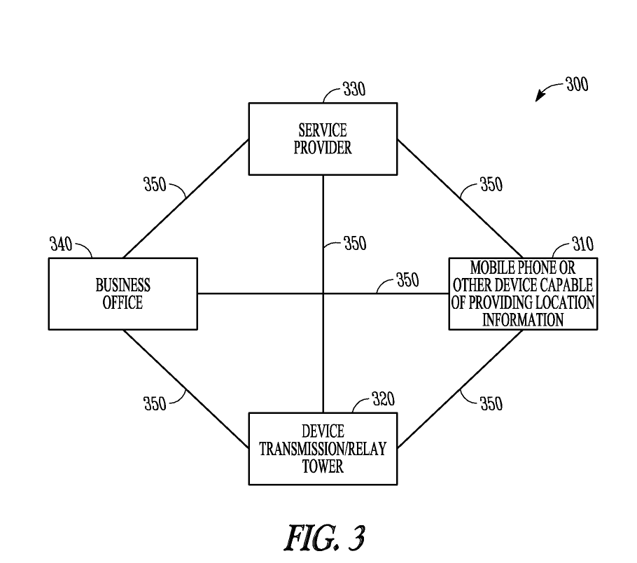

FIG. 3 is a block diagram illustrating a system 300 for determining the location of a person. The system 300 includes a mobile phone or other location device 310, one or more device transmission/relay towers, a service provider 330, and a location 340 such as a business office that can receive a communication from, or transmit a communication to, the mobile phone or location device 310. There are further a plurality of wired and wireless links 350 that couple together the parts of the system 300.

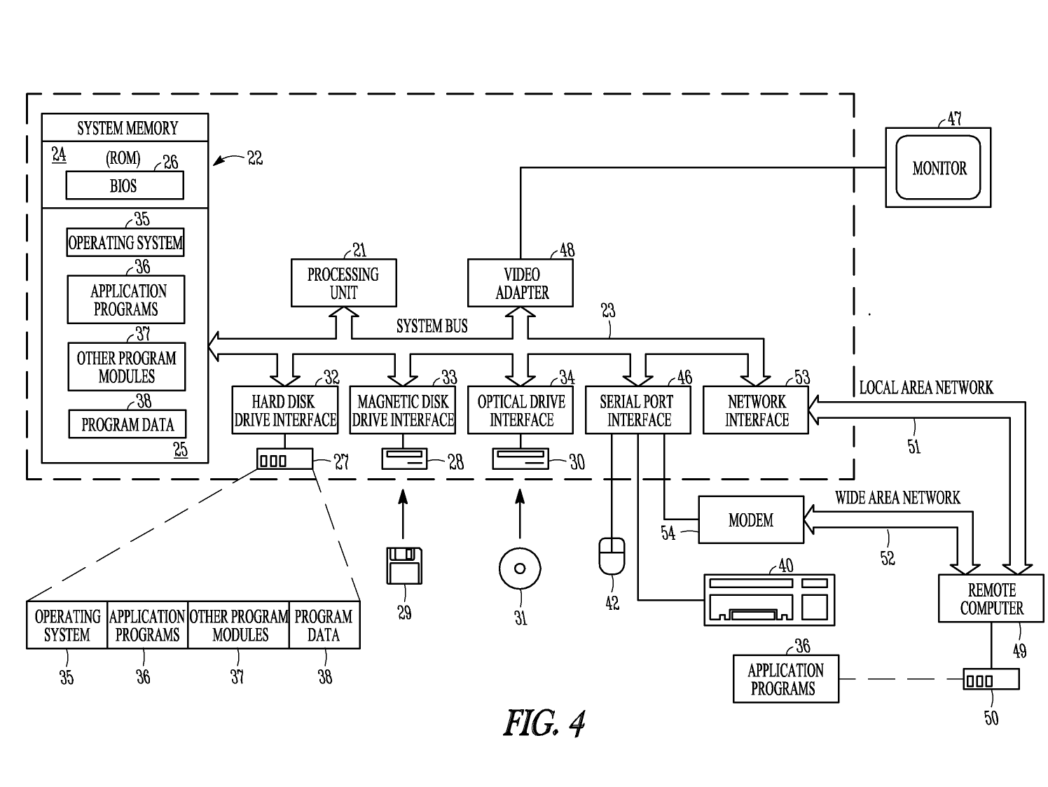

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A computerized process comprising:
receiving, at a processor, data associated with a mobile location device that permits a determination of a location of the mobile location device;
using the data to determine that a person associated with the mobile location device is not at a particular location; and
using the processor, automatically assigning a task of the person associated with the mobile location device to a second person, or automatically transmitting an alert to the second person, as a function of the location of the mobile location device.

2. The computerized process of claim 1, using the processor to determine from a database an association between the mobile location device and the person.

3. The computerized process of claim 1, wherein the location device comprises a mobile phone.

4. The computerized process of claim 1, comprising:
receiving on a periodic basis the data associated with the mobile location device that permits a determination of a location of the mobile location device;
storing the data in a database coupled to the processor; and
analyzing the data to determine one or more locations at which the person has been during a time period.

5. The computerized process of claim 1, comprising:
receiving on a periodic basis the data associated with the mobile location device that permits a determination of a location of the mobile location device;
storing the data in a database coupled to the processor; and
analyzing the data to determine whether the person has been absent from a location over a particular time period.

6. The computerized process of claim 1, comprising coupling the assigning a task to one or more of an issue tracking system, a leave management system, and a work flow management system.

7. The computerized process of claim 6, comprising querying the leave management system to determine if the person is on leave.

8. The computerized process of claim 1, comprising using the processor to determine whether to assign the task to another person as a function of the priority of the task and the amount of time that the person has been away from a location.

9. The computerized process of claim 1, wherein the receiving the data associated with the mobile location device is in connection with a transmission to or from the mobile location device; and wherein the data associated with the mobile location device is transmitted by one or more of the mobile location device or a service provider associated with the mobile location device.

10. The computerized process of claim 1, comprising using the processor to automatically configure an out of office reply message for one or more of the person's voice mail and the person's email.

11. A computer readable medium comprising instructions that when executed by a processor execute a process comprising:
receiving, at a processor, data associated with a mobile location device that permits a determination of a location of the mobile location device;
using the data to determine that a person associated with the mobile location device is not at a particular location; and
using the processor, automatically assigning a task of the person associated with the mobile location device to a second person, or automatically transmitting an alert to the second person, as a function of the location of the mobile location device.

12. The computer readable medium of claim 11, comprising instructions for using the processor to determine from a database an association between the mobile location device and the person.

13. The computer readable medium of claim 11, comprising instructions for receiving data associated with the mobile location device that indicates an amount of time that the person has been absent from a particular location.

14. The computer readable medium of claim 11, comprising instructions for:
receiving on a periodic basis the data associated with the mobile location device that permits a determination of a location of the mobile location device;
storing the data in a database coupled to the processor; and
analyzing the data to determine one or more locations at which the person has been during a time period.

15. The computer readable medium of claim 11, comprising instructions for:
receiving on a periodic basis the data associated with the mobile location device that permits a determination of a location of the mobile location device;
storing the data in a database coupled to the processor; and
analyzing the data to determine whether the person has been absent from a location over a particular time period.

16. The computer readable medium of claim 11, comprising instructions for coupling the assigning a task to one or more of an issue tracking system, a leave management system, and a work flow management system, and comprising instructions for querying the leave management system to determine if the person is on leave.

17. The computer readable medium of claim 11, comprising instructions for using the processor to automatically configure an out of office reply message for one or more of the person's voice mail and the person's email.

18. A system comprising a processor configured to:
receive data associated with a mobile location device that permits a determination of a location of the mobile location device;
using the data to determine that a person associated with the mobile location device is not at a particular location; and
automatically assign a task of the person associated with the mobile location device to a second person, or automatically transmit an alert to the second person, as a function of the location of the mobile location device.

19. The system of claim 18, wherein the processor is configured to couple the assignment of a task to one or more of an issue tracking system, a leave management system, and a work flow management system, and wherein the processor is configured to query the leave management system to determine if the person is on leave.

20. The system of claim 18, wherein the processor is configured to automatically configure an out of office reply message for one or more of the person's voice mail and the person's email.
